(19) United States
(12) Patent Application Publication
(10) Pub. No.: US 2007/0201891 A1
(43) Pub. Date: Aug. 30, 2007

(54) Apparatus and method for controlling fixing unit

(75) Inventor: Jong-hwa Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/636,531

(22) Filed: Dec. 11, 2006

(30) Foreign Application Priority Data
Feb. 24, 2006 (KR) 2006-18429

(51) Int. Cl. G03G 15/20

(52) U.S. Cl. 399/67; 399/69

(57) ABSTRACT

A fixing unit control apparatus and method are provided. The apparatus includes a feeding time detector for detecting a time when a printing medium is fed to the fixing unit; and a heat controller for controlling heat generated by the fixing unit according to the detected time. Accordingly, printing quality degraded in an early print stage can be improved. Also, by reducing a user waiting time to perform a normal printing job after an image forming device is turned on, a more convenient image forming device can be provided.

### CROSS-REFERENCE TO RELATED PATENT APPLICATION

This application claims the benefit under 35 U.S.C. §119(a) of Korean Patent Application No. 10-2006-0018429, filed on Feb. 24, 2006, in the Korean Intellectual Property Office, the entire disclosure of which is hereby incorporated by reference.

### FIELD OF THE INVENTION

The present invention relates to an image forming device such as a printer, a facsimile, or a multi-function peripheral (MFP). More particularly, the present invention relates to a fixing unit, which is included in an image forming device and which fixes a developer to a printing medium using heat.

### DESCRIPTION OF THE RELATED ART

An image forming device that performs a printing job using a laser fixes a developer, to the printing medium using heat generated by a fixing roller included in a fixing unit. In a fixing process of the fixing unit, as illustrated in FIG. 1, when the developer is fixed to the printing medium, a temperature of the fixing unit dramatically drops from t1, t3, t5, t7 and t9 to t2, t4, t6, t8 and t10, respectively, during a fixing time. This drop in temperature occurs due to heat loss.

If a printing job is performed for a long time after the image forming device is turned on, the necessary temperature of the fixing unit is quickly achieved due to a continuous fixing job. However, in early fixing jobs performed when sufficient heat is not generated by the fixing roller, if the printing medium is fed and a fixing job is performed by the fixing unit, the temperature of the fixing unit significantly drops during a period of time from t1 to t2. Accordingly, the developer is abnormally fixed to the printing medium, thereby degrading the printing quality of the image forming device. Also, a user's wait time for performing a normal printing job once the image forming device is turned on increases. This increase in time causes an inconvenience to the user.

Accordingly, there is a need for an improved system and method for controlling temperatures of a fixing unit to generate heat by sensing a position of a printing medium and to decrease the wait time for normal printing jobs once the image forming device has been turned on.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a fixing unit control apparatus and method. A temperature of a fixing unit is controlled to generate heat by sensing a position of a printing medium. A time at which the printing medium is fed to the fixing unit is calculated and a pre-compensation is made for heat that will be lost in a fixing job at a predetermined time.

According to an aspect of an exemplary embodiment of the present invention, an apparatus for controlling a fixing unit is provided. The apparatus comprises a feeding time detector and a heat controller. The feeding time detector detects a time at which a printing medium is fed to the fixing unit and the heat controller controls heat generated by the fixing unit according to the detected time.

The feeding time detector may comprise a printing medium sensor and a feeding time calculator. The printing medium sensor senses the fed printing medium at a predetermined position and the feeding time calculator calculates the time at which the printing medium is fed to the fixing unit using the sensing result.

The printing medium sensor may be located at a predetermined location before a position at which the printing medium is fed to the fixing unit, and the feeding time calculator may calculate the time at which the printing medium is fed to the fixing unit by using the sensed time.

The heat controller may previously supply heat that will be lost in the process of fixing a developer to the printing medium.

The heat controller may additionally supply heat for a predetermined time according to the detected time.

The heat controller may comprise a heat calculator and a heat compensation controller. The heat calculator calculates heat that will be lost during a job of fixing a developer to the printing medium and the heat compensation controller additionally supplies heat at a pre-set time according to the detected time.

The heat controller may additionally supply heat corresponding to pre-set heat at the pre-set time according to the detected time.

According to another aspect of an exemplary embodiment of the present invention, a method of controlling a fixing unit is provided. A time at which a printing medium is fed to the fixing unit is detected and heat generated by the fixing unit is controlled according to the detected time.

During the time at which the printing medium is detected, the fed printing medium is sensed at a predetermined position and the time at which the printing medium is fed to the fixing unit using the sensing result is calculated.

The printing medium may be sensed at a predetermined location before the printing medium is fed to the fixing unit and the time at which the printing medium is fed to the fixing unit may be calculated using the sensed time.

Heat that will be lost in a job of fixing a developer to the printing medium may be previously supplied.

Heat may be additionally supplied for a predetermined time according to the detected time.

Heat that will be lost during a job of fixing a developer to the printing medium is calculated and heat is also supplied at a pre-set time according to the detected time.

Heat corresponding to pre-set heat may also be supplied at the pre-set time according to the detected time.

According to another aspect of an exemplary embodiment of the present invention, a computer readable recording medium for storing a computer readable program for executing the method of controlling a fixing unit is provided.

Other objects, advantages and salient features of the invention will become apparent to those skilled in the art form the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings in which:

FIG. 1 is a graph explaining a problem of a fixing unit control apparatus and method included in a conventional image forming device;

FIG. 2 is a block diagram of an apparatus for controlling a fixing unit according to an exemplary embodiment of the present invention;

FIG. 3 is a flowchart illustrating a method of controlling a fixing unit according to an exemplary embodiment of the present invention;

FIG. 4 is a flowchart illustrating a method of controlling a fixing unit according to another exemplary embodiment of the present invention;

FIG. 5 is a conceptual diagram for explaining the apparatus and method for controlling a fixing unit according to an exemplary embodiment of the present invention; and

FIG. 6 is a graph for explaining the apparatus and method for controlling a fixing unit according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

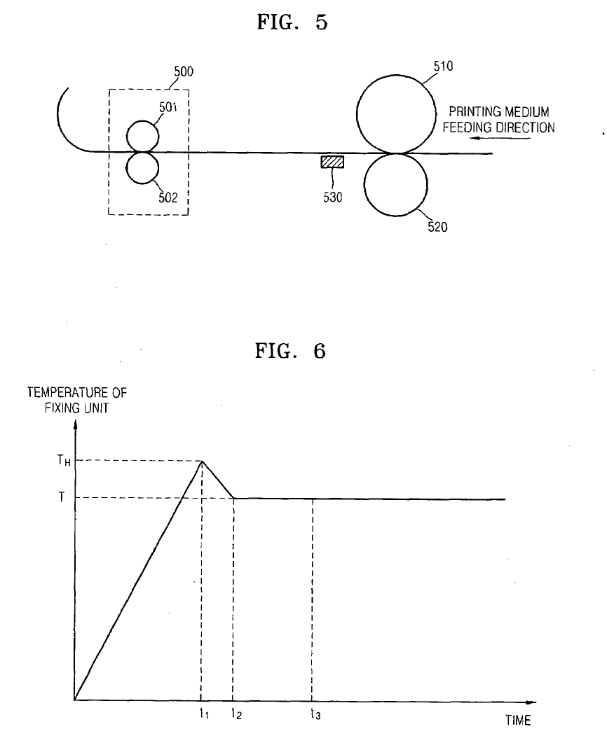

FIG. 2 is a block diagram of a fixing unit control apparatus according to an exemplary embodiment of the present invention. An operation of the fixing unit control apparatus will now be described with reference to FIGS. 5 and 6.

A feeding time detector 200 detects the time at which a printing medium, such as a printing sheet, is fed to a fixing unit 500. The feeding time detector 200 includes a printing medium sensor 203 and a feeding time calculator 206.

The printing medium sensor 203 senses a leading edge or a trailing edge of the printing medium by a sensor 530 located at a predetermined location on a media feeding path before the printing medium is fed to the fixing unit 500 after a transfer job is performed by a developing roller 510 and a transfer roller 520.

The feeding time calculator 206 calculates the time at which the printing medium is fed to the fixing unit 500 using the time at which the fed printing medium is sensed by the sensor 530 of the printing medium sensor 203.

A heat controller 210 controls heat generated by the fixing unit 500 according to the time detected by the feeding time detector 200. As illustrated in FIG. 6, the heat controller 210 generates heat comprising a temperature for compensating for heat that will be lost due to a fixing job at a pre-set time t1 so that a reference temperature T can be maintained even after the fixing job is performed. The heat controller 210 includes a heat calculator 213 and a heat compensation controller 216.

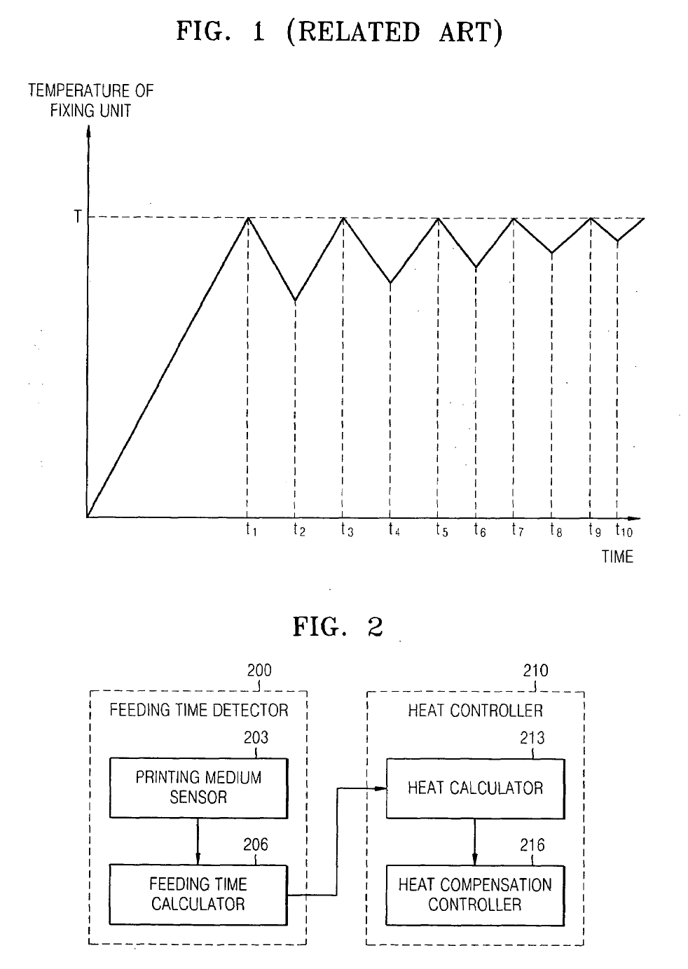

The heat calculator 213 calculates heat that will be lost in the fixing unit 500 to fix a developer, such as a toner, to the printing medium sensed by the printing medium sensor 203. For example, the heat that will be lost in the fixing unit 500 is heat corresponding to a difference between a temperature of the fixing unit 500 at time t1 illustrated in FIG. 1 and a temperature of the fixing unit 500 at the time t2 illustrated in FIG. 1.

The heat compensation controller 216 additionally generates heat, which is calculated by the heat calculator 213, at a pre-set time according to the time calculated by the feeding time calculator 206. That is, the heat compensation controller 216 generates heat corresponding to the heat calculated by the heat calculator 213 in addition to heat supplied to maintain the reference temperature T, which is a temperature to be maintained in the fixing unit 500. The pre-set time is the specific time t1 corresponding to the time before the printing medium is fed to the fixing unit 500 or a specific time duration corresponding to the time before the printing medium is discharged after the printing medium is fed to the fixing unit 500.

In another exemplary embodiment of the present invention, the heat controller 210 additionally generates heat corresponding to pre-set heat at a pre-set time according to the time detected by the feeding time calculator 206. The pre-set time is the specific time t1 corresponding to the time before the printing medium is fed to the fixing unit 500 or a specific time duration corresponding to the time before the printing medium is discharged after the printing medium is fed to the fixing unit 500. The pre-set heat is heat corresponding to a current operational state of an image forming device in a heat supply list table in which amounts of heat to be supplied in the fixing unit 500 are stored in correspondence with factors, such as a lapse time after the image forming device is initialized, the number of printing media fixed by the fixing unit 500, and a current temperature of the fixing unit 500, indicating an operational state of the image forming device. As described above, the heat controller 210 additionally generates pre-set heat in addition to the heat supplied to maintain the reference temperature T.

The fixing unit control apparatus, according to an exemplary embodiment of the present invention, may not operate after a pre-set time t3 because significant variations in the temperature of the fixing unit 500, as in the early fixing jobs, do not exist due to continuous fixing jobs.

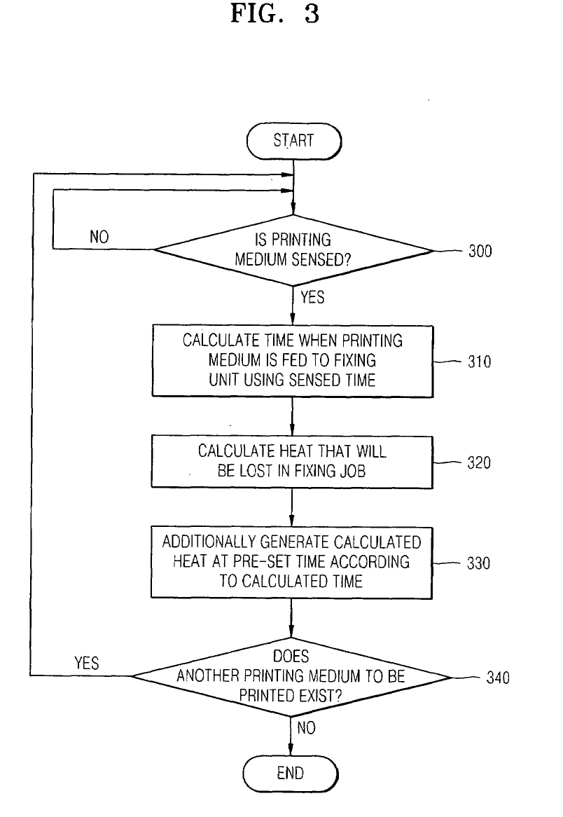

FIG. 3 is a flowchart illustrating a fixing unit control method according to an exemplary embodiment of the present invention. The fixing unit control method, according to an exemplary embodiment of the present invention, will now be described with reference to FIGS. 5 and 6.

In step 300, a determination is made as to whether a leading edge or a trailing edge of a printing medium is sensed by the sensor 530 installed on the media feeding path between the transfer roller 520 and the fixing unit 500 to sense the printing medium before a fixing job is performed after a transfer job. The fixing unit 500 includes a heat roller 501 and a pressure roller 502.

If it is determined in step 300 that the printing medium is sensed, in step 310, the time at which the printing medium is fed to the fixing unit 500 is calculated using the time sensed in step 300.

In step 320, heat that will be lost in the fixing unit 500 to fix a developer, such as a toner, to the printing medium sensed in step 300 is calculated. For example, the heat that will be lost in the fixing unit 500 is heat corresponding to a difference between a temperature of the fixing unit 500 at the time t1 illustrated in FIG. 1 and a temperature of the fixing unit 500 at the time t2 illustrated in FIG. 1.

In step 330, heat corresponding to the heat calculated in step 320 is generated in addition to heat supplied to maintain the reference temperature T, which is a temperature to be maintained in the fixing unit 500, at a pre-set time according to the time calculated in step 310. The pre-set time is the specific time t1 corresponding to the time before the printing medium is fed to the fixing unit 500 or a specific time duration corresponding to the time before the printing medium is discharged after the printing medium is fed to the fixing unit 500. As illustrated in FIG. 6, heat that comprises a temperature to compensate for heat that will be lost due to a fixing job at the pre-set time t1 is generated in step 330 so that the reference temperature T can be maintained even after the fixing job is performed.

In step 340, it is determined whether other printing medium to be printed exists.

If it is determined in step 340 that other printing medium to be printed exists, in step 300, it is determined whether the other printing medium is sensed by the sensor 530.

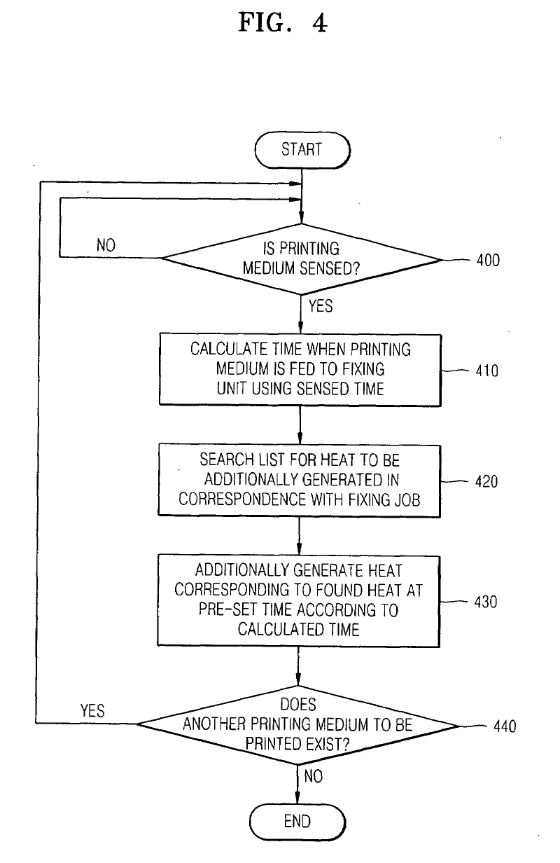

FIG. 4 is a flowchart illustrating a fixing unit control method according to another exemplary embodiment of the present invention. The fixing unit control method, according to an exemplary embodiment of the present invention, will now be described with reference to FIGS. 5 and 6.

In step 400, it is determined whether a leading edge or a trailing edge of a printing medium is sensed by the sensor 530 installed on the media feeding path between the transfer roller 520 and the fixing unit 500 to sense the printing medium before a fixing job is performed after a transfer job.

If it is determined in step 400 that the printing medium is sensed, in step 410, the time when the printing medium is fed to the fixing unit 500 is calculated using the time sensed in step 400.

In step 420, heat to be supplied in the fixing unit 500 is searched for in the heat supply list table. The heat supply list table is a table in which amounts of heat to be supplied in the fixing unit 500 are stored in correspondence with factors, such as a lapse in time after the image forming device is initialized, the number of printing media fixed by the fixing unit 500, and a current temperature of the fixing unit 500, indicating an operational state of the image forming device. In step 420, the factors indicating an operational state of the image forming device are determined, and the heat supply list table is searched for heat corresponding to the determined factors.

In step 430, heat corresponding to the heat calculated in step 420 is additionally generated by the fixing unit 500 at a pre-set time according to the time calculated in step 410. That is, heat corresponding to the heat calculated in step 420 is generated in addition to heat supplied to maintain the reference temperature T, which is a temperature to be maintained in the fixing unit 500. The pre-set time is the specific time t1 which corresponds to the time before the printing medium is fed to the fixing unit 500. Alternatively, the specific time t1 corresponds to a specific time duration corresponding to the time before the printing medium is discharged after the printing medium is fed to the fixing unit 500.

In step 440, it is determined whether another printing medium to be printed exists.

The invention can also be embodied as computer readable codes on a computer (including all kinds of devices comprising an information processing function) readable recording medium. The computer readable recording medium is any data storage device that can store data which can be read by a computer system. Examples of the computer readable recording medium include read-only memory (ROM), random-access memory (RAM), CD-ROMs, magnetic tapes, floppy disks and optical data storage devices.

As described above, a temperature of a fixing unit is controlled to pre-generate heat to compensate for heat to be lost in a fixing job by sensing a position of a printing medium and calculating the time when the printing medium is fed to the fixing unit. This may be done by a fixing unit control apparatus and method according to exemplary embodiments of the present invention.

Thus, printing quality degraded in an early print stage can be improved. In addition, by reducing a user's wait time to perform a normal printing job after an image forming device is turned on, a more convenient image forming device may be provided.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for controlling a fixing unit, the apparatus comprising:
a feeding time detector for detecting a time when a printing medium is fed to a fixing unit; and
a heat controller for controlling heat generated by the fixing unit according to the detected time.

2. The apparatus of claim 1, wherein the feeding time detector comprises:
a printing medium sensor for sensing the fed printing medium at a reference position; and
a feeding time calculator for calculating the time when the printing medium is fed to the fixing unit using the sensing result.

3. The apparatus of claim 2, wherein the printing medium sensor is located at a reference location before a location where the printing medium is fed to the fixing unit, and the feeding time calculator calculates the time when the printing medium is fed to the fixing unit using the sensed time.

4. The apparatus of claim 1, wherein the heat controller previously supplies heat that will be lost in a job of fixing a developer to the printing medium.

5. The apparatus of claim 1, wherein the heat controller additionally supplies heat for a reference time according to the detected time.

6. The apparatus of claim 1, wherein the heat controller comprises:
a heat calculator for calculating heat that will be lost in a job of fixing a developer to the printing medium; and
a heat compensation controller for additionally supplying heat at a pre-set time according to the detected time.

7. The apparatus of claim 1, wherein the heat controller additionally supplies heat corresponding to pre-set heat at the pre-set time according to the detected time.

8. The apparatus of claim 1, wherein the apparatus for controlling a fixing unit is comprised in an image forming device and fixes a developer to a printing medium using heat.

9. A method of controlling a fixing unit, the method comprising the steps of:
detecting a time when a printing medium is fed to a fixing unit; and
controlling heat generated by the fixing unit according to the detected time.

10. The method of claim 9, wherein the detecting comprises:
sensing the fed printing medium at a reference position; and
calculating the time when the printing medium is fed to the fixing unit using the sensing result.

11. The method of claim 10, wherein in the sensing, the printing medium is sensed at a reference location before the printing medium is fed to the fixing unit, and in the calculating, the time when the printing medium is fed to the fixing unit is calculated using the sensed time.

12. The method of claim 9, wherein in the controlling, heat that will be lost in a job of fixing a developer to the printing medium is previously supplied.

13. The method of claim 9, wherein in the controlling, heat is additionally supplied for a reference time according to the detected time.

14. The method of claim 9, wherein the controlling comprises:
calculating heat to be lost in a job of fixing a developer to the printing medium; and
additionally supplying heat at a pre-set time according to the detected time.

15. The method of claim 9, wherein in the controlling, heat corresponding to pre-set heat is additionally supplied at the pre-set time according to the detected time.

16. The method of claim 9, wherein an image forming device fixes a developer to a printing medium using heat.

17. A computer-readable medium having embodied thereon a computer program for executing a method of controlling a fixing unit, which is included in an image forming device and fixes a developer to a printing medium using heat, the method comprising the steps of:
detecting a time when the a printing medium is fed to the a fixing unit; and
controlling heat generated by the fixing unit according to the detected time.

18. The computer-readable medium of claim 17, wherein the detecting comprises:
sensing the fed printing medium at a reference position; and
calculating the time when the printing medium is fed to the fixing unit using the sensing result.

19. The computer-readable medium of claim 18, wherein in the sensing, the printing medium is sensed at a reference location before the printing medium is fed to the fixing unit, and in the calculating, the time when the printing medium is fed to the fixing unit is calculated using the sensed time.

20. The computer-readable medium of claim 17, wherein in the controlling, heat that will be lost in a job of fixing a developer to the printing medium is previously supplied.

21. The computer-readable medium of claim 17, wherein in the controlling, heat is additionally supplied for a reference time according to the detected time.

22. The computer-readable medium of claim 17, wherein the controlling comprises:
calculating heat to be lost in a job of fixing a developer to the printing medium; and
additionally supplying heat at a pre-set time according to the detected time.

23. The computer-readable medium of claim 17 wherein in the controlling, heat corresponding to pre-set heat is additionally supplied at the pre-set time according to the detected time.

24. An apparatus for controlling a fixing unit, the apparatus comprising:
a feeding time calculator for calculating the time when a printing medium is fed to the fixing unit using a sensing result;
a heat calculator for calculating heat that will be lost in a job of fixing a developer to a printing medium; and
a heat compensation controller for additionally supplying heat at a pre-set time according to a detected time.

25. The apparatus of claim 24, further comprising a printing medium sensor for sensing a fed printing medium at a reference position.

26. The apparatus of claim 25, wherein the heat compensation controller produces heat calculated by the heat calculator at a pre-set time according to a time calculated by the feeding time calculator.

27. The apparatus of claim 26, wherein the heat compensation controller generates heat corresponding to the heat calculated by the heat calculator and heat supplied to maintain a reference temperature.

28. The apparatus of claim 27, wherein the reference temperature is a temperature maintained in the fixing unit.

29. An apparatus for controlling a fixing unit, which is included in an image forming device and fixes a developer to a printing medium using heat, the apparatus comprising:
a printing medium sensor for sensing the fed printing medium at a reference position;
a feeding time calculator for calculating a time when the printing medium is fed to the fixing unit; and
a heat controller for controlling heat generated by the fixing unit according to a detected time;
wherein the heat controller supplies heat that will be lost in a job of fixing the developer to the printing medium.

30. The apparatus of claim 29, wherein the printing medium sensor is located at a reference location before a location where the printing medium is fed to the fixing unit, and the feeding time calculator calculates the time when the printing medium is fed to the fixing unit using the sensed time.

31. The apparatus of claim 29, wherein the heat controller supplies heat for a reference time according to the detected time.

32. The apparatus of claim 29, wherein the heat controller comprises:
a heat calculator for calculating heat that will be lost in a job of fixing a developer to the printing medium; and
a heat compensation controller for supplying heat at a pre-set time according to the detected time.

33. The apparatus of claim 29, wherein the heat controller supplies heat corresponding to pre-set heat at the pre-set time according to the detected time.
